(19) United States
(12) Patent Application Publication
(10) Pub. No.: US 2025/0109076 A1
(43) Pub. Date: Apr. 3, 2025

(54) BORON NITRIDE COMPOSITE AND MANUFACTURING METHOD THEREOF

(71) Applicant: WILCO INC., Suwon-si (KR)

(72) Inventors: Jae Min JEONG, Suwon-si (KR); Jong Gu KANG, Suwon-si (KR); Jin Hwan KIM, Suwon-si (KR); Sang Won PARK, Suwon-si (KR)

(21) Appl. No.: 18/980,494

(22) Filed: Dec. 13, 2024

Related U.S. Application Data
(63) Continuation of application No. PCT/IB2023/058166, filed on Aug. 14, 2023.

(51) Int. Cl. C04B 35/583; C04B 35/626; C04B 35/634; C04B 35/638; C04B 35/64; C04B 38/00; C09K 5/14

(52) U.S. Cl. CPC C04B 35/583; C04B 35/6264; C04B 35/62655; C04B 35/62675; C04B 35/6269; C04B 35/62695; C04B 35/63448; C04B 35/638; C04B 35/64; C04B 38/0038; C04B 38/0096; C09K 5/14; C04B 2235/386; C04B 2235/606; C04B 2235/6567; C04B 2235/9607

(57) ABSTRACT

A boron nitride composite is proposed. The boron nitride composite may include an aggregate including a plurality of boron nitride particles bonded to each other to form a plurality of pores. The boron nitride composite may also include a filler containing at least one of an organic material or an inorganic material, and filled in at least some of the plurality of pores such that the organic material and the inorganic material do not cover an outer surface of the aggregate.

### CROSS REFERENCE TO RELATED APPLICATIONS

This is a continuation application of International Patent Application No. PCT/IB2023/058166, filed on Aug. 14, 2023, which claims priority to Korean patent application No. 10-2022-0072407 filed on Jun. 14, 2022, contents of each of which are incorporated herein by reference in their entireties.

### BACKGROUND

### Technical Field

The present disclosure relates to a boron nitride composite and a method of preparing the same.

### Description of Related Technology

The removal of heat from electronic devices or battery systems is becoming increasingly important. Due to the increased processing speed and miniaturization of the devices, the amount of generated heat exponentially increases, causing a problem in that the processing speed of the devices is lowered. As the number of electric vehicles being supplied rises, the use of batteries is increasing.

### SUMMARY

One aspect is a boron nitride composite with improved strength and thermal conductivity and a method of preparing the same.

Another aspect is a boron nitride composite including: an aggregate including a plurality of boron nitride particles bonded to each other to form a plurality of pores; and a filler containing at least one of an organic material and an inorganic material, and filled in at least some of the plurality of pores such that the organic material and the inorganic material do not cover an outer surface of the aggregate.

25% or more of the plurality of pores may be filled with the filler.

The organic material and the inorganic material may be polymers containing two or more atoms of Si, C, N, O, and H.

The organic material may contain at least one of urethane, epoxy, acrylate, polyimide, fluorocarbon, benzocyclobutene, fluorinated polyallyl ether, polyamide, polyimidoamide, cyanate ester, phenolic resin, aromatic polyester, polyarylene ether, bismaleimide, fluororesin, and polybutadiene.

The inorganic material may contain at least one of polysiloxane and polysilazane.

Another aspect is a method of preparing a boron nitride composite, the method including: preparing slurry in which slurry is prepared by adding at least one of a main material, a curing agent, and acetone to an aggregate formed with a plurality of boron nitride particles bonded to each other and stirring the aggregate; removing a solvent in which the slurry is depressurized to remove the acetone and a boron nitride filler mixture is formed; semi-curing the boron nitride filler mixture; removing a filler on an outer surface in which the semi-cured boron nitride filler mixture is put into the solvent and stirred to remove a filler on the outer surface of the semi-cured boron nitride filler mixture; and preparing a composite in which, after removing the filler on the outer surface, the boron nitride filler mixture is cured for a predetermined time and fired for a predetermined time to form a boron nitride composite.

The main material may be polysiloxane A and the curing agent is polysiloxane B, and in the preparing slurry, 0.3 g to 0.7 g of the polysiloxane A, 0.3 g to 0.7 g of the polysiloxane B, and 12 g to 17 g of the acetone may be added to the aggregate to be stirred at a speed of 1,300 rpm to 1,600 rpm.

In the removing the solvent, the slurry may be depressurized at a temperature of 18° C. to 22° C.

In the semi-curing, the boron nitride filler mixture may be semi-cured at a temperature of 75° C. to 100° C. for 8 to 12 minutes.

In the removing the filler on the outer surface, the semi-cured boron nitride filler mixture may be immersed in an MEK solvent of 18 g to 22 g and then stirred at a speed of 1,300 rpm to 1,700 rpm.

In the preparing the composite, the boron nitride filler mixture may be cured at a temperature of 175° C. to 185° C. for 30 minutes to 50 minutes and then fired at a temperature of 680° C. to 710° C. for 110 minutes to 130 minutes.

Si atoms may be provided on the outer surface of the boron nitride filler mixture which has been semi-cured in the semi-curing, and the Si atoms may be removed from the outer surface of the boron nitride filler mixture in the removing the filler on the outer surface.

After the preparing the composite, the preparing slurry, the removing the solvent, the semi-curing, the removing the filler on the outer surface, and the preparing the composite may be repeatedly performed on the boron nitride composite to reduce pores in the boron nitride composite.

According to an embodiment of the present disclosure, it may be possible to reduce the number of pores or eliminate the pores using a filler of a boron nitride composite, enhancing the strength of the boron nitride composite.

In addition, because pores of a boron nitride composite that serve as a heat insulating material are removed and there is no filler on the outer surface of the boron nitride composite, thermal conductivity may be improved.

### BRIEF DESCRIPTION OF DRAWINGS

FIG. 1 is a view of a cross-section of a boron nitride composite according to an embodiment of the present disclosure.

FIG. 2 is a SEM image of the boron nitride composite in FIG. 1.

FIG. 3 is a SEM image of the aggregate in FIG. 1.

FIG. 4 is a flowchart of a method of preparing the boron nitride composite according to an embodiment of the present disclosure.

FIG. 5 is a graph regarding atoms present on the surface of a boron nitride composite prepared by the method of preparing a boron nitride composite according to an embodiment of the present disclosure.

FIG. 6 is a graph regarding atoms present on the surface of a boron nitride composite prepared by the method of preparing a boron nitride composite according to an embodiment of the present disclosure in which a step of removing a filler on the outer surface is skipped.

FIG. 7 is a graph showing thermal conductivity of each of boron nitride composites prepared by the method of preparing a boron nitride composite according to an embodiment of the present disclosure.

### DETAILED DESCRIPTION

Because batteries are very sensitive to heat, the efficiency of batteries decreases when heat is generated, which adversely affects power consumption. In order to remove the increased heat, various complex heat treatment techniques are used. For example, in order to remove heat quickly, a method of connecting a heating part and a heat dissipating part with a material having high thermal conductivity is used. Such a material is a structure formed from copper, aluminum, silicon carbide, metal alloys, polymer composites, ceramic composites, etc., and serves to connect a heating part and a heat dissipating part. However, such a structure is not flat, so it cannot adhere to the heating part and it has pores on the surfaces thereof. Such pores act as an insulator, lowering thermal conductivity.

To fill the pores, a material made by mixing a thermally conductive filler in a polymer matrix is put between the heat transfer surfaces as a thermal bonding material. Examples of such a material include thermal pads, gap fillers, phase change films, thermal tapes, etc. Fillers used for materials filling pores require high thermal conductivity, insulation, compatibility with a matrix, high fluidity, and strength sufficient to withstand a use environment in order to be used for electronic devices or battery systems. Examples of fillers include carbon fillers, alumina (Al2O3), boron nitride (BN), magnesia (MgO), aluminum nitride (AlN), etc. A carbon filler is a conductive material and cannot be used for electronic devices. The thermal conductivity of alumina particles is high at 30 W/(m·K), but does not exceed 5 W/(m·K) when alumina is used as an actual gap filler. In addition, alumina with a high specific gravity of 2.2 or higher is difficult to use for electric vehicles because the specific gravity must be lowered in electric vehicles where weight reduction is important. Boron nitride (BN) has a high thermal conductivity of 300 W/(m·K) or higher and a specific gravity less than half that of alumina, but a plate-like BN has an anisotropic thermal conductivity, having a low thermal conductivity in a vertical direction and a poor fluidity. To solve this problem, an agglomerated BN and a spherical BN, formed by agglomerating a plate-like BN, have been developed, but there is a problem in that because the strength of their particles themselves is low due to pores in the particles, they break during product processing and revert back to the form of a plate-like BN. As a result, they do not have desired high thermal conductivity and may cause reliability problems even when used as final products.

In the case of the agglomerated BN, the form of the particles is improved, but the surface is still poorly compatible with a polymer matrix, resulting in poor dispersibility. Therefore, there are prior studies and patent applications on the technology of coating the surface of an agglomerated BN to increase wettability. In “Composites Science and Technology” p. 141 (2017) 1-7 by Kiho Kim et al. and “Polymers” pp. 13 and 379 (2021) by Seonmin Lee and Jooheon Kim, it has been demonstrated that wettability increases when the surface of an agglomerated BN is coated with polysilazane and that the particle dispersibility and the thermal conductivity of the agglomerated BN are improved. However, because the polysilazane coating the outer surface of the particles of the agglomerated BN has low thermal conductivity and there are still pores inside the particles, the thermal conductivity of the agglomerated BN is far short of the theoretically high thermal conductivity of BN. In addition, nothing is known regarding the strength of the particles themselves.

In the Korean Patent Application Publication No. 10-2007-0051919 by General Electric Co., (Patent Document 1), the outer surface of a spherical BN is coated with sorbitan monostearate of 3% by weight of the spherical BN to secure fluidity in matrix resin and improve compatibility, seeking to fill a high content of BN and increase the adhesive strength. However, because the thermal conductivity decreases when the outer surface of the spherical BN is thickly coated, the amount of the coating layer is limited to 0.5 to 5% by weight of the spherical boron agglomerate.

In the Korean Patent Application Publication Nos. 10-2016-0031255 and 10-2016-0093476 by LG INNOTEK CO., LTD. (Patent Documents 2 and 3), the surfaces of agglomerated boron nitride are coated with polysilazane having thicknesses of 100 nm and 1 to 2 μm, respectively, to secure fluidity in epoxy resin and improve compatibility, seeking to fill a high content of BN and increase the adhesive strength. When the surface of the agglomerated boron nitride is covered with a coating layer of a thickness of 2 μm or more, the thermal conductivity is lowered, so that a large amount of coating is not possible in these patent applications as well the patent application above.

All studies and disclosures that have been carried out to date have aimed only at improving compatibility with a matrix by coating only the outer surface of an agglomerated boron nitride, and there is a limit to enhancing the strength and the thermal conductivity of the particles because there are still pores that act as an insulating material inside the particles.

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘bonded’ to another element, it should be understood that the element may be directly bonded to another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side, the lower side, and side surface are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a boron nitride composite 1 according to an embodiment of the present disclosure will be described with reference to the accompanying drawings.

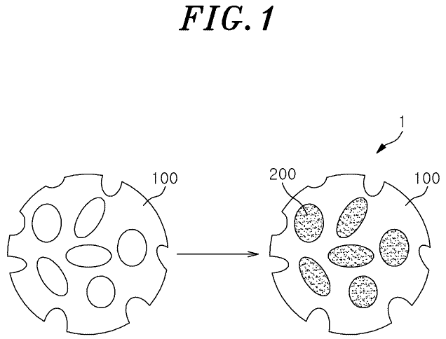

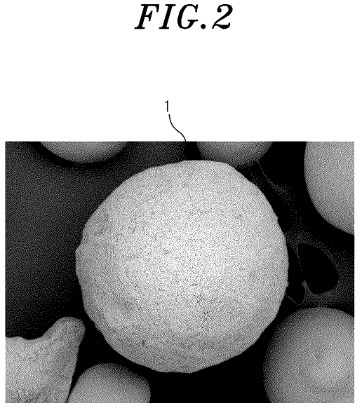

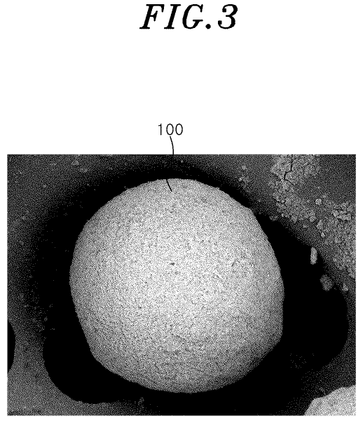

Referring to FIGS. 1 to 3, the boron nitride composite 1 according to an embodiment of the present disclosure may include an aggregate 100 and a filler 200. The boron nitride composite 1 may be a hybrid composite including at least one of organic and inorganic materials.

The aggregate 100 may be formed with a plurality of boron nitride particles bonded to each other. The aggregate 100 may be formed in a substantially spherical shape or a substantially polyhedral shape. For example, the aggregate 100 may be formed in a spherical shape by bonding a plurality of plate-shaped boron nitride particles to each other. In addition, a plurality of pores 110 may be formed in the aggregate 100 while the plurality of boron nitride particles are bonded to each other. In other words, the plurality of pores 110 may be formed inside the aggregate 100. Furthermore, one side of at least some of the plurality of pores 110 may be opened so that the pores may be filled with the filler 200. In other words, at least some of the plurality of pores 110 may be formed by being drawn inward from an outer surface of the aggregate 100, and at least some of the pores inside the aggregate 100 may communicate with each other. In addition, the aggregate 100 may be in the form of particle having a substantially spherical shape or a substantially polyhedral shape.

The filler 200 may be filled in at least some of the plurality of pores 110 of the aggregate 100 and disposed inside the outer surface of the aggregate 100. That is, the filler 200 may prevent the plurality of pores 110 in the aggregate 100 from being filled with air. For example, the filler 200 may fill 25% or more of the plurality of pores 110. The filler 200 may be provided only inside the aggregate 100, and may not be provided on the outer surface of the aggregate 100. In other words, the filler 200 may not come into contact with the outer surface of the aggregate 100 and may not cover the outer surface of the aggregate 100. In addition, the filler 200 may not be exposed on the outer surface of the aggregate 100, and may be provided only inside the aggregate 100.

The filler 200 may contain at least one of organic and inorganic materials. These organic and inorganic materials may be polymers containing at least two atoms of Si, C, N, O, and H. In other words, there may be no organic (C and O atoms) and inorganic (Si atom) materials on the outer surface of the aggregate 100.

The organic material may contain at least one of urethane, epoxy, acrylate, polyimide, fluorocarbon, benzocyclobutene, fluorinated polyallyl ether, polyamide, polyimidoamide, cyanate ester, phenolic resin, aromatic polyester, polyarylene ether, bismaleimide, fluororesin, and polybutadiene. Such an organic material may be provided in at least some of the plurality of pores 110 so as not to come into contact with the outer surface of the aggregate 100.

The inorganic material may contain at least one of polysiloxane and polysilazane. Such an inorganic material may be provided in at least some of the plurality of pores 110 so as not to come into contact with the outer surface of the aggregate 100.

Hereinafter, actions and effects of the boron nitride composite according to an embodiment of the present disclosure will be described.

The number of the pores 110 of the boron nitride composite 1 according to an embodiment of the present disclosure may be reduced by the filler 200, or they may be eliminated by the filler 200, so that both strength and thermal conductivity of the boron nitride composite 1 may be improved. In other words, even when the boron nitride composite 1 is processed or used for a final product, it may not be broken. In addition, the number of the pores 110 in the boron nitride composite 1 may be reduced, and the filler 200 may not be provided on the outer surface of the boron nitride composite 1, so that thermal conductivity may be enhanced.

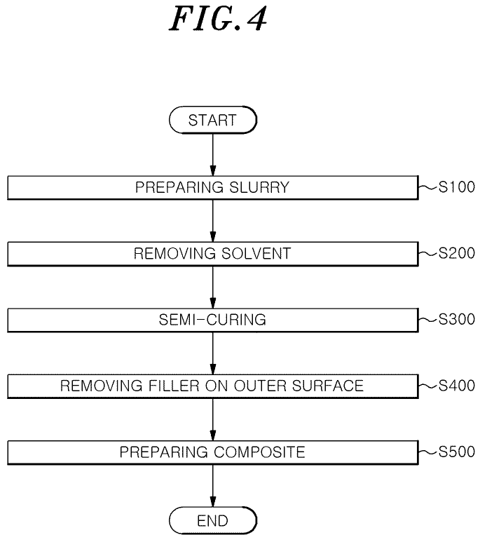

Hereinafter, with reference to FIG. 4, the method of preparing the boron nitride composite according to an embodiment of the present disclosure will be described.

The method of preparing the boron nitride composite may include the step S100 of preparing slurry, the step S200 of removing a solvent, the step S300 of semi-curing, the step S400 of removing a filler on the outer surface, and the step S500 of preparing the composite.

In the step of preparing slurry S100, to prepare slurry, at least one of a main material, a curing agent, and acetone may be added to the aggregate 100 formed with a plurality of boron nitride particles bonded with each other, and the aggregate 100 may be stirred with a stirrer. In other words, a filling solution containing at least one of a main material, a curing agent, and acetone may be added to the aggregate 100. The main material may be polysiloxane A, and the curing agent may be polysiloxane B. The weight of the aggregate 100 may be 10 g. In addition, the plurality of pores 110 may be formed in the aggregate 100 formed with a plurality of boron nitride particles bonded with each other. The porosity of the aggregate 100 may be 30% to 60%.

In the step of preparing slurry S100, 0.3 g to 0.7 g of polysiloxane A, 0.3 g to 0.7 g of polysiloxane B, and 12 g to 17 g of acetone may be added to the aggregate 100. In the step of preparing slurry S100, a stirrer may stir the aggregate 100 at a speed of 1,300 rpm to 1,600 rpm.

In the step S200 of removing the solvent, the slurry may be depressurized to remove the acetone, and a boron nitride filler mixture may be formed. For example, the boron nitride filler mixture may be a BN-PSO mixture. In addition, in the step S200 of removing the solvent, the slurry may be depressurized at a temperature of 18° C. to 22° C. in a vacuum oven.

In the step S300 of semi-curing, the boron nitride filler mixture may be semi-cured. In the step S300 of semi-curing, the boron nitride filler mixture may be semi-cured at a temperature of 75° C. to 100° C. for 8 to 12 minutes in a vacuum oven. The semi-curing may mean curing the entire boron nitride filler mixture until 25% to 45% of the total amount of heat to be generated is generated.

In the step S400 of removing the filler on the outer surface, the semi-cured boron nitride filler mixture may be put into a solvent and stirred to remove the filler on the outer surface of the semi-cured boron nitride filler mixture. In the step S400, the semi-cured boron nitride filler mixture may be immersed in an MEK solvent of 18 g to 22 g and then stirred at a speed of 1,300 rpm to 1,700 rpm.

The step S500 of preparing the composite may be taken after the step S400 of removing the filler on the outer surface. In the step S500, the boron nitride filler mixture may be cured for a predetermined period of time and fired for a predetermined period of time to form the boron nitride composite. In the step S500, the boron nitride filler mixture may be cured at a temperature of 175° C. to 185° C. for 30 minutes to 50 minutes and then fired at a temperature of 680° C. to 710° C. for 1 hour 50 minutes to 2 hours 10 minutes.

In addition, after the step S500 of preparing the composite, to reduce the pores in the boron nitride composite, with a boron nitride composite, the step S100 of preparing slurry, the step S200 of removing the solvent, the step S300 of semi-curing, the step S400 of removing the filler on the outer surface, and the step S500 of preparing the composite may be repeated several times. That is, by the first round of taking, with a boron nitride composite, the step S100 of preparing slurry with the boron nitride aggregate, the step S200 of removing the solvent, the step S300 of semi-curing, the step S400 of removing the filler on the outer surface, and the step S500 of preparing the composite, a first boron nitride composite may be prepared. By taking, with the first boron nitride composite, the step S100 of preparing slurry with the boron nitride aggregate, the step S200 of removing the solvent, the step S300 of semi-curing, the step S400 of removing the filler on the outer surface, and the step S500 of preparing the composite, a second boron nitride composite may be prepared. By taking, with the second boron nitride composite, the step S100 of preparing slurry with the boron nitride aggregate, the step S200 of removing the solvent, the step S300 of semi-curing, the step S400 of removing the filler on the outer surface, and the step S500 of preparing the composite, a third boron nitride composite may be prepared. In addition, by taking, with the third boron nitride composite, the step S100 of preparing slurry with the boron nitride aggregate, the step S200 of removing the solvent, the step S300 of semi-curing, the step S400 of removing the filler on the outer surface, and the step S500 of preparing the composite, a fourth boron nitride composite may be prepared. The fourth boron nitride composite may have fewer pores than other boron nitride composites.

Hereinafter, actions and effects of the method of preparing a boron nitride composite according to an embodiment of the present disclosure will be described.

Since it may be possible to reduce the number of the pores 110 in the boron nitride composite 1 prepared by the method of preparing a boron nitride composite according to the embodiment of the present disclosure or to eliminate the pores 110, both strength and thermal conductivity of the boron nitride composite 1 may be improved. In addition, since the filler 200 may not be provided on the outer surface of the boron nitride composite 1, thermal conductivity may be enhanced.

Table 1 below shows porosity, percentage of filled pores, average pore diameter, and compressive strength of a first boron nitride composite, a second boron nitride composite, a third boron nitride composite, a fourth boron nitride composite, Comparative Example 1, Comparative Example 2, and Comparative Example 3. Comparative Example 1 is the aggregate 100 having a porosity of 50%. Comparative Example 2 is a boron nitride composite with a percentage of filled pores of 20%, prepared by the method of preparing a boron nitride composite according to the embodiment of the present disclosure, where a smaller amount of polysiloxane A, polysiloxane B, and acetone were added to the aggregate 100. In addition, Comparative Example 3 is a boron nitride composite prepared by the method of preparing a boron nitride composite according to the embodiment of the present disclosure, where the step S400 of removing the filler on the outer surface was skipped. The porosities and the pore diameters were measured by the mercury intrusion method according to the ISO 15901-1 standard. The compressive strengths were measured at a speed of 1 mN/s with a micro compression test (MCT; fisher h100c) when the composites were destroyed. In addition, the compressive strengths are average values of values collected by measuring 10 times.

TABLE 1

| | | Filled pore (%) | | |
|---|---|---|---|---|
| | | (100 − (Composite | | |
| | | Porosity/Aggregate | Avg. Pore diameter | Compressive |
| | Porosity (%) | Porosity) * 100) | (um) | Strength (MPa) |
| First boron | 39.3 | 25.0 | 7.4 | 78 |
| nitride | | | | |
| composite | | | | |
| Second boron | 26.1 | 50.2 | 4.9 | 150 |
| nitride | | | | |
| composite | | | | |
| Third boron | 12.9 | 75.4 | 2.4 | 250 |
| nitride | | | | |
| composite | | | | |
| Fourth boron | 0.37 | 99.3 | 0.1 | 300 |
| nitride | | | | |
| composite | | | | |
| Comparative | 52.4 | 0 | 9.8 | 10 |
| Example 1 | | | | |
| Comparative | 41.92 | 20.0 | 7.8 | 13 |
| Example 2 | | | | |
| Comparative | 39.5 | 24.6 | 1.3 | 83 |
| Example 3 | | | | |

Table 1 shows that, as each step of the method of preparing a composite according to the embodiment of the present disclosure is repeated several times, the porosity and the diameter of the pores 110 decrease, and the percentage of filled pores increases. In other words, in the case of the first boron nitride composite prepared by taking each step once, the porosity is 39.3%, 25% of the pores 110 are filled with the filler 200, and the diameter of the pore 110 is 7.4 μm. In the case of the second boron nitride composite prepared by taking each step twice, the porosity is 26.1%, 50.2% of the pores 110 are filled with the filler 200, and the diameter of the pore 110 is 4.9 μm. In addition, in the case of the third boron nitride composite prepared by taking each step three times, the porosity is 12.9%, 75.4% of the pores 110 are filled with the filler 200, and the diameter of the pore 110 is 2.4 μm. Furthermore, in the case of the fourth boron nitride composite prepared by taking each step four times, the porosity is 0.37%, 99.3% of the pores 110 are filled with the filler 200, and the diameter of the pores 110 is 0.1 μm. It is seen that the compressive strengths are improved as each step of the method of preparing a composite according to the embodiment of the present disclosure is repeated several times. In other words, the compressive strength of the first boron nitride composite is 78 MPa, the compressive strength of the second boron nitride composite is 150 MPa, the compressive strength of the third boron nitride composite is 250 MPa, and the compressive strength of the fourth boron nitride composite is 300 MPa.

In addition, the compressive strength of the boron nitride composite 1 prepared by repeating each step of the method of preparing the boron nitride composite according to the embodiment of the present disclosure two or more times may be higher than those of Comparative Example 1, Comparative Example 2, and Comparative Example 3. In other words, while the compressive strength of the second boron nitride composite is 150 MPa, the compressive strength of Comparative Example 1 is 10 MPa, the compressive strength of Comparative Example 2 is 13 MPa, and the compressive strength of Comparative Example 3 is 83 MPa.

Table 2 below shows the percentages of components on the outer surface of the boron nitride composite 1 and the percentages of components on the outer surface of Comparative Example 3.

TABLE 2

| | | Comparative |
|---|---|---|
| Mass (%) | First boron nitride composite | Example 3 |
| B | 41.51 | 25.76 |
| C | 5.96 | 18.18 |
| N | 49.24 | 26.19 |
| O | 3.29 | 22.39 |
| Si | 0 | 7.48 |
| Total | 100.00 | 100.00 |

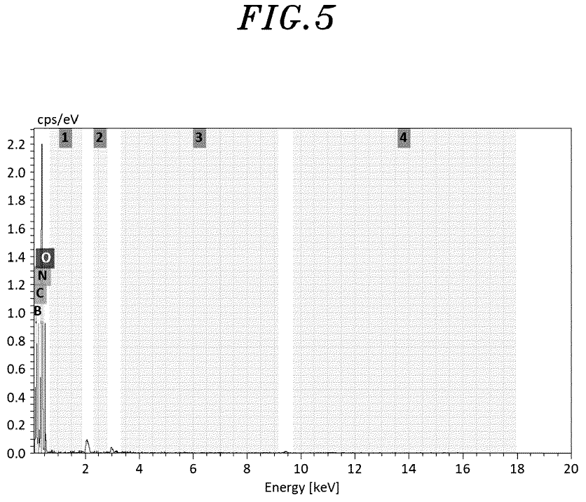

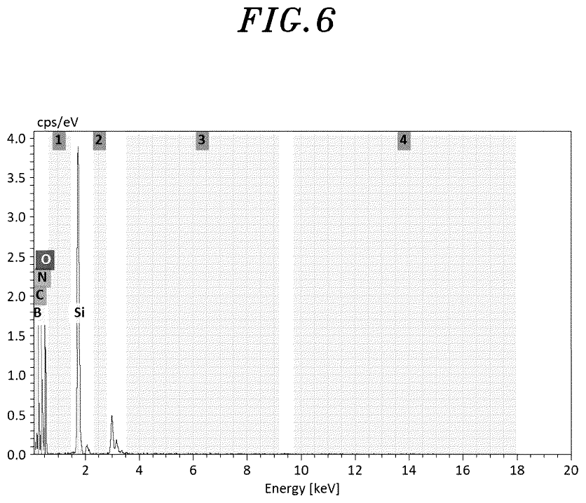

Referring to Table 2 and FIGS. 5 and 6, B accounting for 41.51%, C accounting for 5.96%, N accounting for 49.24%, and O accounting for 3.29% may be detected on the outer surface of the boron nitride composite. In addition, B accounting for 25.76%, C accounting for 18.18%, N accounting for 26.19%, O accounting for 22.39%, and Si accounting for 7.49% may be detected on the outer surface of Comparative Example 3. In other words, in the step S400 of removing the filler on the outer surface, Si (inorganic material) may be completely removed from the outer surface of the boron nitride composite 1, and most of C and O (organic materials) may also be removed. That is, since it may be possible to allow the outer surface of the boron nitride composite 1 to consist of a large amount of boron nitride (BN), thermal conductivity may be enhanced. Table 3 below shows a comparison of the particle diameter (μm) of each of the first boron nitride composite, the second boron nitride composite, the third boron nitride composite, the fourth boron nitride composite, Comparative Example 1, Comparative Example 2, and Comparative Example 3 with a mesh number (Mesh No.), which is the mesh standard.

TABLE 3

| | Mesh No. | | | | | |
|---|---|---|---|---|---|---|
| | 120 | 140 | 170 | 200 | 230 | |
| | um | | | | | |
| | 125 | 106 | 90 | 75 | 63 | Total |
| First boron | 0.4 | 47.9 | 45.1 | 5.5 | 1.1 | 100 |
| nitride | | | | | | |
| composite | | | | | | |
| Second boron | 0.4 | 48.2 | 45.9 | 4.6 | 0.9 | 100 |
| nitride | | | | | | |
| composite | | | | | | |
| Third boron | 0.4 | 48.1 | 45.1 | 5.5 | 0.9 | 100 |
| nitride | | | | | | |
| composite | | | | | | |
| Fourth boron | 0.4 | 47.9 | 45 | 5.6 | 1.1 | 100 |
| nitride | | | | | | |
| composite | | | | | | |
| Comparative | 0.4 | 48 | 45 | 5.6 | 1 | 100 |
| Example 1 | | | | | | |
| Comparative | 0.4 | 47.5 | 45.2 | 5.7 | 1.2 | 100 |
| Example 2 | | | | | | |
| Comparative | 0.6 | 49.2 | 46.4 | 3.7 | 0.1 | 100 |
| Example 3 | | | | | | |

Referring to Table 3, in the case of the first boron nitride composite, there may be 0.4 w % of the pores 110 having a diameter of 125 μm at Mesh No. 120, there may be 47.9 w % of the pores 110 having a diameter of 106 μm at Mesh No. 140, there may be 45.1 w % of the pores 110 having a diameter of 90 μm at Mesh No. 170, there may be 5.5 w % of the pores 110 having a diameter of 75 μm at Mesh No. 200, and there may be 1.1 w % of the pores 110 having a diameter of 63 μm at Mesh No. 230. Table 4 below shows the result of measuring the thermal conductivity of each of the first boron nitride composite, the second boron nitride composite, the third boron nitride composite, the fourth boron nitride composite, a plate-like boron nitride, Comparative Example 1, Comparative Example 2, and Comparative Example 3, prepared as silicon pads. This thermal conductivity can be measured according to the ASTM D5470 with the DynTIM equipment.

TABLE 4

| | Number of times of measurements (time(s)) | | | | |
|---|---|---|---|---|---|
| | 1 | 2 | 3 | 6 | 10 |
| | Thermal | Thermal | Thermal | Thermal | Thermal |
| | conductivity | conductivity | conductivity | conductivity | conductivity |
| | (W/mK) | (W/mK) | (W/mK) | (W/mK) | (W/mK) |
| First boron | 26.4 | 23.7 | 22.4 | 21.2 | 20.6 |
| nitride composite | | | | | |
| Second boron | 27.9 | 27.4 | 26.7 | 25.6 | 24.9 |
| nitride composite | | | | | |
| Third boron | 28.4 | 28.3 | 28.2 | 27.9 | 27.9 |
| nitride composite | | | | | |
| Fourth boron | 30.2 | 30.2 | 30.2 | 30.1 | 30.1 |
| nitride composite | | | | | |
| Plate-like | 7.2 | 7.2 | 7.2 | 7.2 | 7.2 |
| boron nitride | | | | | |
| Comparative | 25.5 | 13.3 | 10.1 | 7.9 | 7.2 |
| Example 1 | | | | | |
| Comparative | 26.1 | 15.7 | 13.5 | 10.5 | 9.6 |
| Example 2 | | | | | |
| Comparative | 20.8 | 17.4 | 16.1 | 14.9 | 14.3 |
| Example 3 | | | | | |

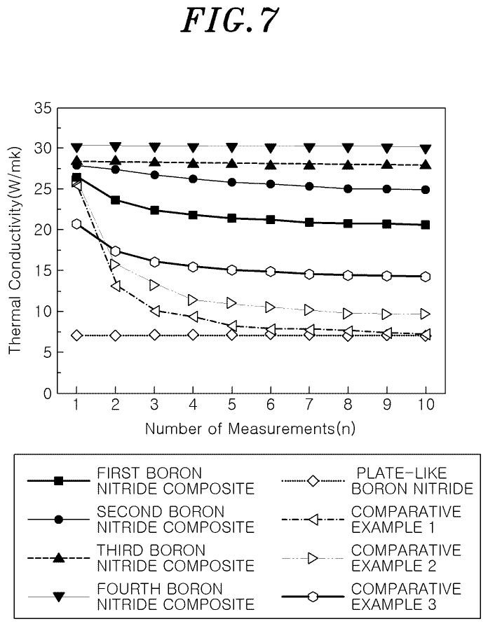

Referring to Table 4 and FIG. 7, as the number of times of preparing the boron nitride composite increases, the value of the thermal conductivity may increase. In other words, the value of the thermal conductivity of the first boron nitride composite measured for the first time is 26.4 W/mK, the value of the thermal conductivity of the second boron nitride composite measured for the first time is 27.9 W/mK, the value of the thermal conductivity of the third boron nitride composite measured for the first time is 28.4 W/mK, and the value of the thermal conductivity of the fourth boron nitride composite measured for the first time is 30.2 W/mK. In addition, when the number of times of measuring the thermal conductivity increases, the extent of decrease in the thermal conductivity may decrease as the number of times of preparing the boron nitride composite increases. In other words, the value of the thermal conductivity of the first boron nitride composite measured for the first time is 26.4 W/mK, and the value of the thermal conductivity measured for the second time is 23.7 W/mK, which means a decrease of approximately 7%. The value of the thermal conductivity of the second boron nitride composite measured for the first time is 27.9 W/mK, and the value of the thermal conductivity measured for the second time is 27.4 W/mK, which means a decrease of approximately 1.7%.

In addition, when the number of times of measuring the thermal conductivity increases, the extent of decrease in the thermal conductivity of Comparative Example 1, Comparative Example 2, and Comparative Example 3 may be greater than the extent of decrease in the thermal conductivity of the boron nitride composite. The value of the thermal conductivity of Comparative Example 1 measured for the first time is 25.6 W/mK, and the value of the thermal conductivity measured for the second time is 13.4 W/mK, which means a decrease of approximately 47%. Furthermore, the value of the thermal conductivity of Comparative Example 2 measured for the first time is 26.1 W/mK, and the value of the thermal conductivity measured for the second time is 15.7 W/mK, which means a decrease of approximately 39%. In other words, the extent of decrease in the thermal conductivity of the boron nitride composite 1 prepared by the method of preparing the boron nitride composite may be less. In the meantime, the measured value of the thermal conductivity of the plate-like boron nitride is 7.2 W/mK, which is lower than that of the boron nitride composite.

In addition, since there is no filler 200 on the surface of the aggregate 100, the values of the thermal conductivity of the first boron nitride composite, the second boron nitride composite, the third boron nitride composite, and the fourth boron nitride composite may be higher than that of Comparative Example 3 having the filler on the outer surface.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A boron nitride composite comprising:
an aggregate including a plurality of boron nitride particles bonded to each other to form a plurality of pores; and
a filler containing at least one of an organic material or an inorganic material, and filled in at least some of the plurality of pores such that the organic material and the inorganic material do not cover an outer surface of the aggregate.

2. The boron nitride composite of claim 1, wherein 25% or more of the plurality of pores are filled with the filler.

3. The boron nitride composite of claim 1, wherein the organic material and the inorganic material are polymers containing two or more atoms of Si, C, N, O, or H.

4. The boron nitride composite of claim 1, wherein the organic material contains at least one of urethane, epoxy, acrylate, polyimide, fluorocarbon, benzocyclobutene, fluorinated polyallyl ether, polyamide, polyimidoamide, cyanate ester, phenolic resin, aromatic polyester, polyarylene ether, bismaleimide, fluororesin, or polybutadiene.

5. The boron nitride composite of claim 1, wherein the inorganic material contains at least one of polysiloxane or polysilazane.

6. A method of preparing a boron nitride composite, the method comprising:
preparing slurry in which slurry is prepared by adding at least one of a main material, a curing agent, or acetone to an aggregate formed with a plurality of boron nitride particles bonded to each other and stirring the aggregate;
removing a solvent in which the slurry is depressurized to remove the acetone and a boron nitride filler mixture is formed;
semi-curing the boron nitride filler mixture;
removing a filler on an outer surface in which the semi-cured boron nitride filler mixture is put into the solvent and stirred to remove a filler on the outer surface of the semi-cured boron nitride filler mixture; and
preparing a composite in which, after removing the filler on the outer surface, the boron nitride filler mixture is cured for a predetermined time and fired for a predetermined time to form a boron nitride composite.

7. The method of claim 6, wherein the main material is polysiloxane A and the curing agent is polysiloxane B, and
wherein in the preparing slurry, 0.3 g to 0.7 g of the polysiloxane A, 0.3 g to 0.7 g of the polysiloxane B, and 12 g to 17 g of the acetone are added to the aggregate to be stirred at a speed of 1,300 rpm to 1,600 rpm.

8. The method of claim 6, wherein, in the removing the solvent, the slurry is depressurized at a temperature of 18° C. to 22° C.

9. The method of claim 6, wherein, in the semi-curing, the boron nitride filler mixture is semi-cured at a temperature of 75° C. to 100° C. for 8 minutes to 12 minutes.

10. The method of claim 6, wherein, in the removing the filler on the outer surface, the semi-cured boron nitride filler mixture is immersed in an MEK solvent of 18 g to 22 g and then stirred at a speed of 1,300 rpm to 1,700 rpm.

11. The method of claim 6, wherein, in the preparing the composite, the boron nitride filler mixture is cured at a temperature of 175° C. to 185° C. for 30 minutes to 50 minutes and then fired at a temperature of 680° C. to 710° C. for 110 minutes to 130 minutes.

12. The method of claim 6, wherein Si atoms are provided on the outer surface of the boron nitride filler mixture which has been semi-cured in the semi-curing, and the Si atoms are removed from the outer surface of the boron nitride filler mixture in the removing the filler on the outer surface.

13. The method of claim 6, wherein, after the preparing the composite, the preparing slurry, the removing the solvent, the semi-curing, the removing the filler on the outer surface, and the preparing the composite are repeatedly performed on the boron nitride composite to reduce pores in the boron nitride composite.
